(19) United States
(12) Patent Application Publication
(10) Pub. No.: US 2004/0087734 A1
(43) Pub. Date: May 6, 2004

(54) Polyamide compositions with improved antistatic and hydrophilic properties

(76) Inventors: Jean- Pierre Bianchi, Charmes sur Rhone (FR); Bertrand Bordes, Vienne (FR); Olivier Chaubet, Valence (FR); Sandrine Rochat, Villeurbanne (FR); Eric Roche, Luzinay (FR)

Correspondence Address: BURNS DOANE SWECKER & MATHIS L L P, POST OFFICE BOX 1404, ALEXANDRIA, VA, 22313-1404, US

(21) Appl. No.: 10/312,872

(22) PCT Filed: Jul. 3, 2001
(86) PCT No.: PCT/FR01/02128

(30) Foreign Application Priority Data
Jul. 3, 2000 (FR) 0008632

(51) Int. Cl. C08L 77/00; C08L 71/00

(52) U.S. Cl. 525/425; 525/430

(57) ABSTRACT

The invention relates to polyamide compositions having improved antistatic behaviour and/or improved hydrophilicity. These compositions are particularly suitable for the manufacture of polyamide-based yarns, fibres and filaments. The compositions comprise polyamide and a modifier containing polyether units, which modifies the antistatic and/or hydrophilic properties.

The present invention relates to polyamide compositions having improved antistatic behaviour and/or improved hydrophilicity. These compositions are particularly suitable for the manufacture of polyamide-based yarns, fibres and filaments.

In the field of the formulation of synthetic materials, it is often sought to modify the antistatic and/or hydrophilic properties so as to impart on the said material better workability, to impart on the final product better comfort in use or to provide adaptation to the external environment.

In the field of textile yarns, it is sought, for example, to improve the hydrophilicity of polyamides so as to make their properties similar to those of cotton and to provide better comfort.

In the field of yarns, fibres and filaments, antistatic behaviour may be necessary for reasons of comfort in use. It makes it possible inter alia to prevent the build-up of electric charges. One of the effects may, for example, be to limit the build-up of dust on flocked surfaces. In addition, the use of an intrinsically antistatic fibre may make it possible to avoid the use, from among the fibres used for producing flocked surfaces, of a highly conducting fibre usually having a strong coloration. One may therefore expect clearer dyes and colours which are less grey.

To improve the antistatic behaviour or the hydrophilicity of a polyamide or a polyamide-based composition, it is known to use polyether units. Very many documents describe different ways of introducing such units into the polyamide, for example in the form of polymer or copolymer blends, or in combination with the polyamide, for example in the form of bicomponent fibres.

The document “Hydrophilic nylon for improved apparel comfort”, Textile Research Journal, June 1985, pages 325-333, describes the manufacture and the properties of a copolymer obtained by the polycondensation of caprolactam and of amine-terminated polyethylene oxides. The copolymer is melt-spun in order to manufacture yarns. The yarns exhibit improved hydrophilicity over a conventional polyamide. However, this method requires the manufacture of special copolymers and therefore means that the polymerization processes have to be adapted.

It may be preferable to modify the properties of the polyamide by adding an agent in the melt. Within the context of the manufacture of spun articles, the agent may, for example, be added in the melt before spinning.

For this purpose, it is known to introduce polyethylene glycol into the polyamide. However, this water-soluble compound is greatly extracted from the compositions in contact with water. Its effect does not last beyond a few washings.

Also known are compositions obtained by the addition to the polyamide of random copolymers obtained from caprolactam and amine-terminated polyethylene oxides. These compositions again suffer a relatively high loss of properties after washing.

It is an object of the present invention to provide novel, especially melt-spinable, compositions which do not have the abovementioned drawbacks. In particular, the compositions according to the invention also have a satisfactory, that is to say sufficiently light, coloration.

For this purpose, the invention provides a thermoplastic polymer composition comprising a polyamide and at least one compound for modifying the hydrophilicity and/or the antistatic behaviour, characterized in that the compound is a block polymer represented by formula (I):

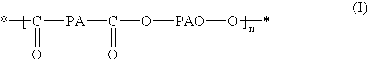

in which,

n is an integer between 5 and 50

PAO represents a polyalkylene oxide block

PA represents a polyamide block, the repeat unit of which is represented by either of formulae (IIa) and (IIb):

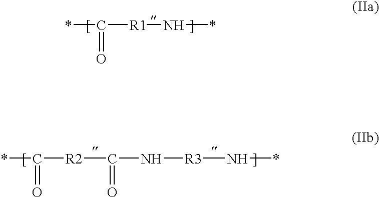

in which

R1, R2, R3 are aromatic or aliphatic radicals comprising 4 to 36 carbon atoms.

The block copolymer represented by formula (I) is a polyether-block-amide or a polyether ester amide. Such compounds are especially sold by Atofina under the name PEBAX®. They comprise polyamide blocks and polyalkylene glycol blocks. The number of blocks of each kind is between 3 and 50 and preferably between 10 and 15. The number of blocks is represented by the integer n in formula (I).

The polyamide blocks may be represented by either of the formulae (IIa) and (IIb) shown above. The blocks of formula (IIa) are polyamides of the type obtained by polymerization starting from lactams and/or amino acids. The processes for polymerizing such compounds are known: mention may be made inter alia of anionic polymerization and melt polycondensation, for example in a VK tube.

The blocks (IIb) are of the type obtained by the polycondensation of dicarboxylic acids on amines.

The radicals R₁, R₂, R₃ are aromatic or aliphatic radicals comprising 4 to 36 carbon atoms.

According to one embodiment, in which the polyamide block is represented by formula (IIa), the radical R1 is advantageously chosen from the following radicals:

the unbranched divalent pentyl radical, the polyamide block then being a nylon-6 block;

the unbranched divalent decyl radical (containing 10 carbon atoms), the polyamide block then being a nylon-11 block;

the unbranched divalent undecyl radical (containing 11 carbon atoms), the polyamide block then being a nylon-12 block.

According to the embodiment in which the polyamide block is represented by formula (IIb), the pairs of radicals R₂ and R₃ are advantageously chosen from the following pairs:

R₂=divalent linear butyl radical and R₃=divalent linear hexyl radical, giving a nylon-6,6 block;

R₂=divalent linear butyl radical and R₃=divalent linear butyl radical, giving a nylon-4,6 block;

R₂=divalent linear octyl radical and R₃=divalent linear hexyl radical, giving a nylon-6,10 block.

The polyalkylene oxide block may be chosen from polyethylene oxide, polytrimethylene oxide and polytetramethylene oxide blocks. If the block is based on polyethylene oxide, it may have propylene glycol units at the ends of the block.

The average molecular masses of each of the blocks are independent of each other. However, it is preferred for them to be similar to each other.

The average molecular mass of the PAO blocks is preferably between 1000 and 3000 g/mol. The average molecular mass of the PA blocks is advantageously between 1000 and 3000 g/mol.

The compound of formula (I) may be obtained by the catalysed reaction between polyamide macromolecular chains, the terminal functional groups of which are carboxylic acid functional groups, and polyether diol chains, that is to say polyalkylene oxide macromolecular chains, the terminal functional groups of which are alcohol functional groups. They may, for example, be alcoholterminated polyethylene glycol chains.

The reaction between the terminal functional groups of the blocks may be catalysed by tetraalkylorthotitanates or zirconyl acetate.

The compositions of the invention may include several modifying compounds of different type, for example two compounds of different type.

In order to implement the invention, it is preferred to use compounds of formula (I) with the least pronounced colour possible. As such, it is preferred to use compounds whose yellow index is low. The catalyst used to obtain the compound may have an influence on its colour. As such, it is preferred to use the abovementioned catalysts. The colour of the compound used has an influence on the colour of the composition obtained. The colour characteristics are very critical in certain fields of application, for example in the textile field.

According to one particular embodiment of the invention, the modifying compounds of formula (I) have a melting point of greater than 150° C., preferably between 150 and 250° C.

The compositions according to the invention are obtained by melt blending the polyamide with the compound for modifying the hydrophilicity and/or the antistatic behaviour. The blend may, for example, be produced using an extruder, for example a single-screw or twin-screw extruder.

The proportion by weight of modifying compound in the composition is preferably between 4 and 20%.

The compositions according to the invention have a morphology in which inclusions of the modifying compound are dispersed within a continuous polyamide phase.

The compositions, apart from the modifier, may include other additives such as delustrants, coloured pigments, heat or light stabilizers, heat protection agents, antimicrobial agents, antisoiling agents or the like. This list is in no way exhaustive.

The compositions may, in particular, contain a delustrant consisting of titanium dioxide particles possibly coated so as to protect the polymer from degradation in contact therewith. The titanium dioxide may be used by itself or in combination with other delustrants. The proportion by weight of delustrant in the compositions may be up to a few percent. For example, it is between 0.2 and 0.5% for an effect called “semi-dull”, between 0.5 and 1% for an effect called “dull” and between 1% and 2% for an effect called “fully dull”. To obtain a level of mattness regarded as significant, the weight concentration is generally greater than 0.7%.

It is also possible to use zinc sulphide particles as a delustrant, or else a titanium dioxide/zinc sulphide mixture.

The polyamide of the composition may be chosen from nylon-6, nylon-6,6, nylon-4,6, nylon-6,10, nylon-11, nylon-12 and blends and copolymers based on these polymers.

The invention also relates to the yarns, fibres and filaments obtained by spinning a composition described above. These may be continuous textile yarns intended to be woven or knitted, BCF yarns used for the manufacture of carpets, flock cables intended to be cut into very short fibres for flocking, fibres used for the production of staple fibre yarns, or non-woven surfaces.

The compositions are melt-spun by extrusion through spinnerets. The blend of the polyamide and the compound for modifying the hydrophilicity and/or the antistatic behaviour may be produced in a specific operation before the spinning, the composition being solidified, for example, in the form of granules and then melted in order to be spun. The blend may also be produced just before spinning, by introducing into the spinning device the polyamide on the one hand and the modifier on the other.

Spinning processes are known. In short, they consist in extruding the molten material through a spinneret and in cooling the filaments obtained. The filaments are generally made to converge beneath the spinneret and collected so as to undergo treatments such as drawing, texturizing, sizing, relaxing, dyeing and heat-setting treatments. This list is not exhaustive. The treatments may be carried out on a relatively small number of filaments, for the manufacture of yarns for example, or on a large number of filaments joined together in the form of a cable, lap or roving, for the manufacture of, for example, fibres or flocked cable.

The yarns and filaments according to the invention may lie within a wide linear density range, possibly having linear densities from less than 0.5 dtex up to linear densities of greater than 500 dtex.

The fibres and filaments may have various cross-sectional shapes such as round or multilobate cross sections. The cross section may also include hollows. They are generally obtained from a single material. However, they may also be obtained from two or more materials. These fibres or filaments are called composite or bicomponent fibres or filaments of the “side by side” or “core/shell” type.

The yarns, fibres and filaments obtained from the composition are more hydrophilic and/or antistatic than a polyamide, with good preservation of those properties after dyeing or washing.

The compositions according to the invention can be used to produced flocked surfaces. In this case, the flocked fibres consist either exclusively of fibres of the composition according to the invention or partially thereof in combination with other fibres.

The technique of flocking is known. In short, it consists in spraying fibres of very short length onto a surface coated with an adhesive so that the fibres remain on the surface. For example, textile surfaces, yarns and articles may be flocked in this way. The length of the fibres is generally less than 10 mm and is preferably between 0.2 and 3 mm. They are usually dyed after being cut and before being sprayed, but it is possible to dye the surface after spraying, or to use fibres which include colour pigments (bulk-coloured fibres). An electrostatic field is used to spray the fibres, these being activated beforehand. The activation operation consists in giving the fibres an electric charge. The flocking may be carried out by vibrating the substrate, by electrostatic means, or else by a combination of the two. For example, for electrostatic flocking, the fibre must be able to conduct charges so that it is oriented and sprayed in the electrostatic field. The charge is conferred by an activation treatment. Two broad families of activation treatments are known: treatments based on natural tannins and those based on colloidal silica. In all cases, these are non-permanent surface treatments which favour a high water uptake.

In certain cases, depending on the activation process used, the activation is facilitated as compared with fibres not containing the modifier. The modifier may therefore allow all or part of the activation treatment to be omitted.

The surfaces flocked by fibres according to the invention make it possible to obtain good flow of the electric charges without the need to add highly conducting fibres having a colour different from that of the fibres covering most of the surface. Consequently, the flocked surfaces also attract much less dust than the surfaces obtained using conventional polyamide fibres.

Further details or advantages of the invention will become more clearly apparent in the light of the examples given below solely by way of indication.

### EXAMPLES 1 TO 5

Materials Used:

| | |
|---|---|
| Polyamide: | nylon-6,6 containing 0.3% by weight of titanium dioxide |
| | particles, having a relative viscosity of 41 (measured with |
| | 8.4% of polymer in 90% formic acid); |
| Additive A: | PEBAX ® MH1657 sold by Atofina, a multisegmented |
| | block polymer comprising 50% by weight of nylon-6 blocks |
| | and 50% by weight of polyethylene glycol blocks, the |
| | average molecular mass of each block of which is about |
| | 1500 g/mol. Melting pint: 204° C. according to ASTM |
| | D3418; |
| Additive B: | IRGASTAT P22 sold by Ciba-Geigy. Melting point: |
| | 212-220° C.; |
| Additive C: | A7220, an additive sold by BASF, derived from the family |
| | of tetronics; |
| Additive D: | polyethylene glycol having an average molecular mass of |
| | 35 000 g/mol. |

Granules comprising the polyamide and one of the additives were produced by extrusion in a twin-screw extruder with each of the additives being fed in granule form. The compositions thus produced are given in Table I

TABLE I

| | | | Compara- | Compara- | Compara- |
|---|---|---|---|---|---|
| | | | tive | tive | tive |
| | Example 1 | Example 2 | Example 3 | Example 4 | Example 5 |
| Polyamide | 95% | 90% | 100% | 95% | 95% |
| (% by | | | | | |
| weight | | | | | |
| Additive | A-5% | A-10% | — | D-5% | C-5% |
| (% by | | | | | |
| weight) | | | | | |

Yarns were melt-spun from the granules produced. The spinning was followed by drawing between a first godet and an intermediate godet, without taking up the yarn. The spinning temperature was 275° C., the speed of the first, feed godet was 400 m/min, the speed of the intermediate godet was 1200 m/min and the wind-up speed was 1200 m/min. The yarn was sized using the compound BK2170 sold by Henkel. The yarn produced had a linear density of 130 dtex for 20 filaments. The filaments coming from several wound packages were combined in order to form an approximately 700 ktex cable. Using a guillotine-type cutter, the cable was cut at a speed of 200 cuts per minute into fibres having an average length of 2 mm.

The antistatic behaviour of these fibres, corresponding to the as-cut flock, was measured using a “Mahlo tester” having 2 circular electrodes, the fibres being preconditioned at 60% RH at 20° C. The correspondence between the Mahlo scale and the resistivity in Ωcm is given below in Table II.

TABLE II

| | | | | |
|---|---|---|---|---|
| Mahlo conductivity | 0 | 10 | 30 | 70 |
| Approximate resistivity | 10¹⁴ | 10¹¹ | 10¹⁰ | 10⁸ |
| [Ω.cm] | | | | |

The antistatic behaviour was measured before and after 2 washings. Each washing was carried out by immersing the fibres for 30 minutes in a bath of demineralized water at 95° C. The bath ratio (weight of fibres to weight of water) was 1/25. This operation was repeated twice. The washing operation simulates the treatments that the product may have to undergo: dyeing and washing. The moisture uptake was measured by weighing. The fibres were conditioned at a relative humidity (RH) of 95% and at a temperature of 30° C. in an environmental chamber for 24 hours. Their wet mass was then measured. The fibres were then put into a vacuum oven at 80° C. for 16 h and their dry mass then measured. The moisture uptake was then calculated from:

moisture uptake=(wet mass—dry mass)/dry mass.

The loss of moisture absorption gain compared with nylon-6,6 alone (Example 3), on washing, was also calculated from:

loss of moisture absorption gain=(moisture absorption gain over nylon-6,6 alone in % before washings−moisture absorption gain over nylon-6,6 alone in % after washings)/moisture absorption gain over nylon-6,6 alone in % before washings.

The results are given in Table III.

TABLE III

| Examples | 1 | 2 | 3 | 4 | 5 |
|---|---|---|---|---|---|
| Antistatic behaviour before washing | 20 | 30 | 5 | 15 | 25 |
| (Mahlo) | | | | | |
| Antistatic behaviour after washing | 15 | 25 | 0 | 5 | 15 |
| (Mahlo) | | | | | |
| Loss of antistatic behaviour on washing | 25% | 16% | — | 66% | 40% |
| Moisture absorption before washings | 6.7 | 7.5 | 6.2 | 7.5 | 7.2 |
| (wt %) | | | | | |
| Moisture absorption after washings | 6.7 | 7.5 | 6.2 | 6.2 | 6.5 |
| (wt %) | | | | | |
| Loss of moisture absorption gain on | 0% | 0% | — | 100% | 70% |
| washing | | | | | |

The fibres obtained from compositions according to the invention exhibit good antistatic behaviour and good hydrophilicity, with strong retention of these properties after washing.

### EXAMPLES 6 TO 10

Fibres obtained according to the previous examples were activated using a treatment based on natural tannins which give the fibre good properties for moving in an electrostatic field. The activated fibres were dried for 2 h in an oven at 60° C. and then conditioned at a relative humidity of 60% and a temperature of 20° C. Next, a cotton cloth was coated with an acrylic adhesive using a doctor blade, to a thickness of 15/100 cm. The surface was placed in a field of 35 kV, the distance between the two electrodes being 18 cm. The flocking was carried out manually for one minute. The adhesive was then dried and crosslinked for 10 minutes at 130° C. followed by 10 minutes at 160° C. Next, the surface was washed in demineralized water at 40° C. for 20 minutes.

Examples 6 to 10 correspond to the flocked surfaces obtained with the fibres described in Table IV. In the case of Example 10, the fibres used for the flocking contain 99.5% of fibres according to Example 3 and 0.5% of R-Stat black conducting fibres sold by Bayer; this is a formulation widely used by producers of antistatic flocked surfaces.

The colour of the flocked surface was evaluated visually, 0 denoting a natural colour or colour close to natural colour, while X indicates a grey coloration of the surface.

The results obtained for the flocked surfaces are given in Table IV.

TABLE IV

| Examples | 6 | 7 | 8 | 9 | 10 |
|---|---|---|---|---|---|
| Fibres used for the flocking | 100% | 100% | 100% | 100% | |
| | Ex. 1 | Ex. 2 | Ex. 3 | Ex. 5 | |
| Antistatic behaviour of the flocked | 20 | 35 | 5 | 10 | 25 |
| surface (Mahlo) | | | | | |
| Colour | ◯ | ◯ | ◯ | ◯ | X |

It may be seen that the flocked surface obtained with the fibres of the invention has at least as good antistatic behaviour as that observed for surfaces obtained by flocking with a mixture of conventional fibres and of highly conducting fibres, while eliminating grey coloration of the surface.

### EXAMPLES 11 TO 14

Granules comprising the polyamide and one or more additives were produced by extrusion in a twin-screw extruder as previously. The compositions produced in this way are given in Table V.

TABLE V

| | Example | Example | Example | Comparative |
|---|---|---|---|---|
| | 11 | 12 | 13 | Example 14 |
| Polyamide | 95% | 90% | 90% | 100% |
| (wt %) | | | | |
| Additive | A-5% | A-10% | B-10% | — |
| (wt %) | | | | |

Yarns were melt-spun from the granules produced. The spinning was followed by drawing with uptake of the yarn. The spinning temperature was 280° C., the take-up speed was 500 m/min, the drawing speed was 611 m/min and the temperature of the godet was 90° C. The yarn was sized with a specific sizing composition. The yarn produced had a linear density of 68.4 dtex for 36 filaments.

The resistivity of these yarns, which were conditioned in a Heraeus Votsch environmental chamber of the HC2020 type at a relative humidity of 60% or 20% and at a temperature of 20° C., was measured using a DM500A-type Sefelec megohmmeter between two points 0.7 cm apart. The results obtained are given in Table VI.

TABLE VI

Examples

| | | | | 14 |
|---|---|---|---|---|
| | | | | (compar- |
| | 11 | 12 | 13 | ative) |
| Resistivity in | 6 × 10⁷ | 2 × 10⁷ | 4 × 10⁷ | 7 × 10⁸ |
| ohm.cm at 60% | | | | |
| RH | | | | |
| Resistivity in | 8 × 10⁸ | 3 × 10⁸ | 2 × 10⁹ | 6 × 10⁹ |
| ohm.cm at 20% | | | | |
| RH | | | | |

The yarns obtained from compositions according to the invention spin easily, in comparison with products having a lower melting point. They exhibit good antistatic behaviour for a relative humidity of 60%. In addition, the yarns produced with additive retain good antistatic behaviour even for a relative humidity of 20%.

1. Thermoplastic polymer composition comprising a polyamide and at least one compound for modifying the hydrophilicity and/or the antistatic behaviour, characterized in that the compound is a block polymer represented by formula (I): 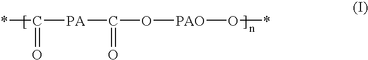
in which,
n is an integer between 3 and 50
PAO represents a polyalkylene oxide block
PA represents a polyamide block, the repeat unit of which is represented by either of formulae (IIa) and (IIb): 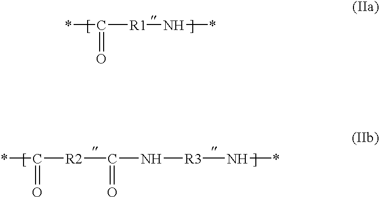
in which
R1, R2, R3 are aromatic or aliphatic radicals comprising 4 to 36 carbon atoms.

2. Composition according to claim 1, characterized in that the radical R1 is a pentyl divalent linear radical and in that the polyalkylene oxide block is a polyethylene oxide block.

3. Composition according to either of the preceding claims, characterized in that the average molecular mass of the PAO block is between 1000 and 3000 g/mol.

4. Composition according to one of claims 1 to 3, characterized in that n is between 10 and 15.

5. Composition according to one of the preceding claims, characterized in that the average molecular mass of a PA block is between 1000 and 3000 g/mol.

6. Composition according to claim 1, characterized in that the polymer block is obtained by the catalysed reaction between:
polyamide chains whose terminal functional groups are carboxylic acids;
polyether diol chains, the catalyst being chosen from tetraalkylorthotitanates and zirconyl acetate.

7. Composition according to one of the preceding claims, characterized in that the proportion by weight of the compound for modifying the antistatic behaviour and/or hydrophilicity in the composition is between 4 and 20%.

8. Composition according to one of the preceding claims, characterized in that the compound modifying the antistatic behaviour and/or hydrophilicity has a melting point of greater than 150° C., preferably between 150 and 250° C.

9. Composition according to one of the preceding claims, characterized in that it includes a delustrant.

10. Composition according to claim 9, characterized in that the delustrant is based on zinc sulphide.

11. Composition according to claim 9, characterized in that the delustrant is based on titanium dioxide, by itself of in combination with another delustrant.

12. Composition according to one of claims 9 to 11, characterized in that the proportion by weight of delustrant in the composition is greater than 0.7%.

13. Composition according to one of the preceding claims, characterized in that the polyamide is chosen from nylon-6, nylon-6,6 and blends and copolymers thereof.

14. Yarns, fibres and filaments obtained by spinning a composition according to one of the preceding claims.

15. Flocked surfaces, the flocked fibres of which consist, completely or partly, of a composition according to one of claims 1 to 13,
